(19) United States
(12) Patent Application Publication
(10) Pub. No.: US 2013/0020851 A1
(43) Pub. Date: Jan. 24, 2013

(54) Car seat riser for the lower part of the thighs

(71) Applicant: Benoit Therrien, JR., St-Jean-Baptiste (CA)

(72) Inventor: Benoit Therrien, JR., St-Jean-Baptiste (CA)

(21) Appl. No.: 13/554,078

(22) Filed: Jul. 20, 2012

(30) Foreign Application Priority Data
Jul. 21, 2011 (GB) 1112534.1

(51) Int. Cl. B60N 2/62

(52) U.S. Cl. 297/423.4

(57) ABSTRACT

A car seat riser for the lower part of the thighs has a body member having an L-shaped cross-section in a first axial direction and a W-shaped cross-section in a perpendicular axial direction to the first axial direction; the body member has a front edge that is thicker than a back edge thereby forming the body member in the shape of an L-shaped wedge in the first axial direction; and having an inner surface formed by the L-shaped cross-section that is adapted to conform to and fit upon a front edge portion of the seat portion of the car seat to thereby position the cars seat riser in proper position upon the seat portion, such that a user can sit in the car seat with the car seat riser wedged under the user's thighs thereby supporting and lifting the user's legs in a more comfortable and proper position.

This application claims priority based on request GB1112534.1 filed Jul. 21, 2011

### FIELD OF THE INVENTION JUL. 21, 2011

The present invention relates generally to seat accessories but more particularly to a leg riser to increase comfort of car users.

### BACKGROUND OF THE INVENTION

There are many types of seat cushions, padding, risers, etc. Each type having specific functions. Some are meant to rise short drivers who need good visibility and typically, they raise the entire driver from the posterior all the way to the back of the knees. There are no seat cushions designed for tall people.

### SUMMARY OF THE INVENTION

In view of the foregoing disadvantages inherent in the known devices now present in the prior art, the present invention, which will be described subsequently in greater detail, is to provide objects and advantages which are:

To provide for a seat cushion that raises the knees and the thighs so that a tall person has more leg room by having is legs raised while still being supported.

In order to do so, the car seat riser has a body member having an L-shaped cross-section in a first axial direction and a W-shaped cross-section in a perpendicular axial direction to the first axial direction; the body member has a front edge that is thicker than a back edge thereby forming the body member in the shape of an L-shaped wedge in the first axial direction; and having an inner surface formed by the L-shaped cross-section that is adapted to conform to and fit upon a front edge portion of the seat portion of the car seat to thereby position the cars seat riser in proper position upon the seat portion, such that a user can sit in the car seat with the car seat riser wedged under the user's thighs thereby supporting and lifting the user's legs in a more comfortable and proper position.

The car seat riser further comprises at least one loop member connected to the inner surface and at least one strap member adapted to be placed through the at least one loop member and adapted to be wrapped around the car seat to securely hold the car seat riser in place upon the seat portion of the car seat.

At least one loop member is connected to a bottom portion of the front edge, and at least one strap member is adapted to be placed through the at least one loop member and adapted to be wrapped around the car seat to securely hold the car seat riser in place upon the seat portion of the car seat.

At least one strap member includes a blocking member at one end adapted to prevent the end of the strap from being pulled through the at least one loop member; and wherein the at least one strap member includes a hook on an opposite end thereof from the blocking member adapted for removably securing to any portion of the car seat.

At least two loop members connect to the inner surface, wherein two of the at least two loop members are attached such that the loop of at least one loop member is connected at a 90 degree angle with respect to a second of the at least two loop members, thereby resulting in a configuration wherein the at least one strap member can be used to secure the car seat riser to the seat portion of the car seat either from a direction following the first axial direction or the perpendicular axial direction.

The W-shaped cross-section is formed including left, right, and center straight ridges that are adapted to offer support to a user's thighs in the first axial direction.

The at least one strap member is adjustable in length.

The car seat riser is formed as having a rigid shape formed by a molded rigid material; and further includes a compressible material surrounding and enclosing the molded rigid material, such that the car seat riser retains its shape yet also offers comfort to a user.

The car seat riser works in combination with a car seat and the invention can be seen as a combination of the two, i.e. a car seat and a car seat riser.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1 a-b Side views of a car and a truck respectively and showing the invention in context.

FIG. 2 Isometric view of the invention.

FIG. 3 Isometric view of the invention installed on a car seat.

FIGS. 4a-e Side cutaway, front, and side view, respectively, of the invention, and front and side views of the embodiment with straps at the front and back.

FIGS. 5a-b Side views of a user without and with the invention.

FIG. 6 Side view detail of the blocker.

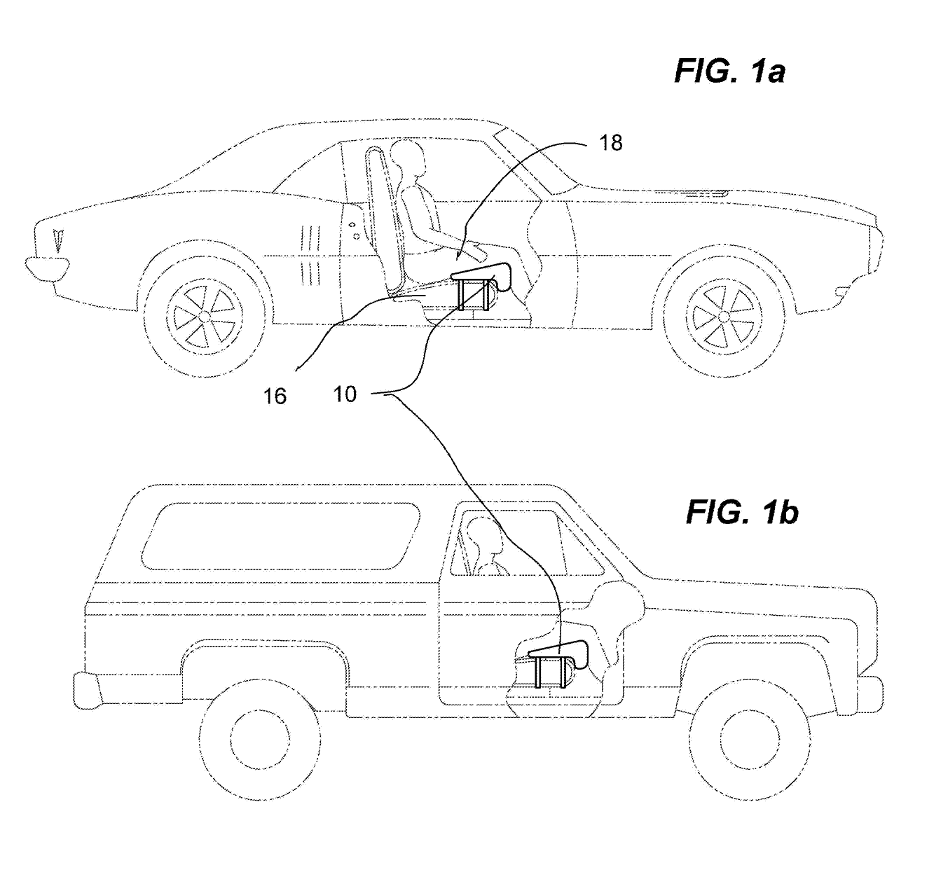

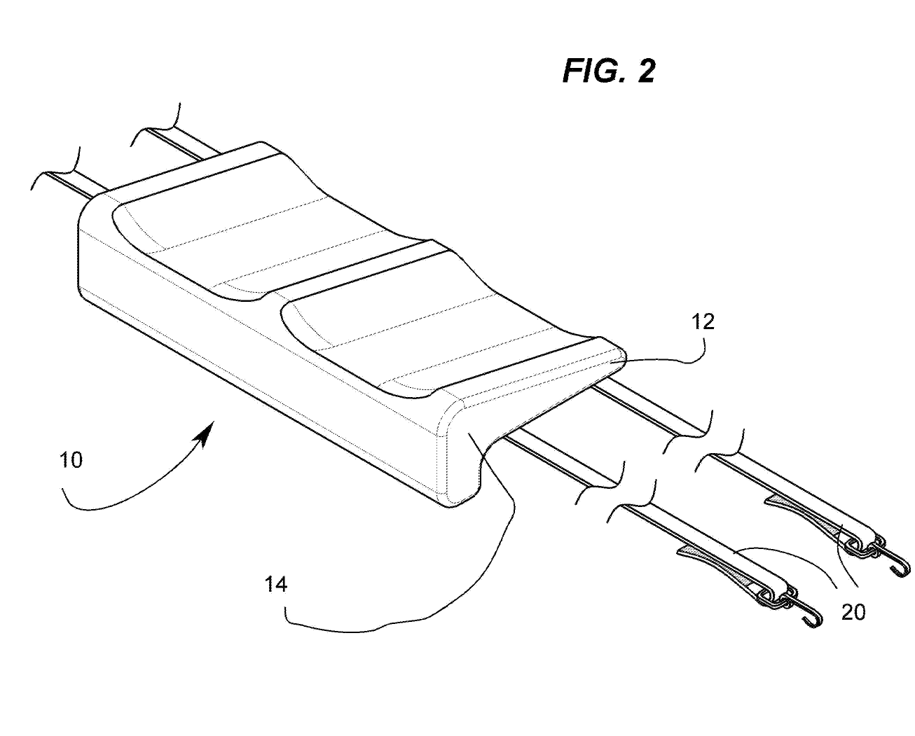

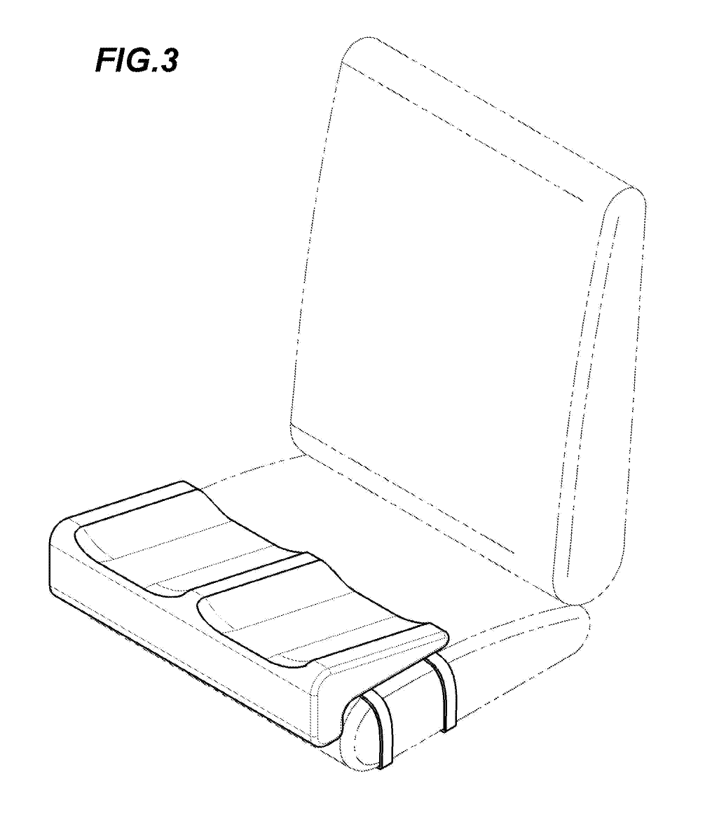

### DETAILED DESCRIPTION OF THE PREFERRED EMBODIMENT

A car seat riser (10) for the lower part of the thighs has a body member comprised of has a thin rear edge portion (12) and a thick front edge portion (14), which give it an L-shape. The car seat riser (10) is located at the front edge portion of a car seat (16) so as to raise the lower part of a user's thighs (18). A set of adjustable straps (20) secure the car seat riser (10) to the car seat (16). The straps (20) are adjustable by making them shorter or longer using hook and loop attachment means but other means known in the art of adjustable straps can be used.

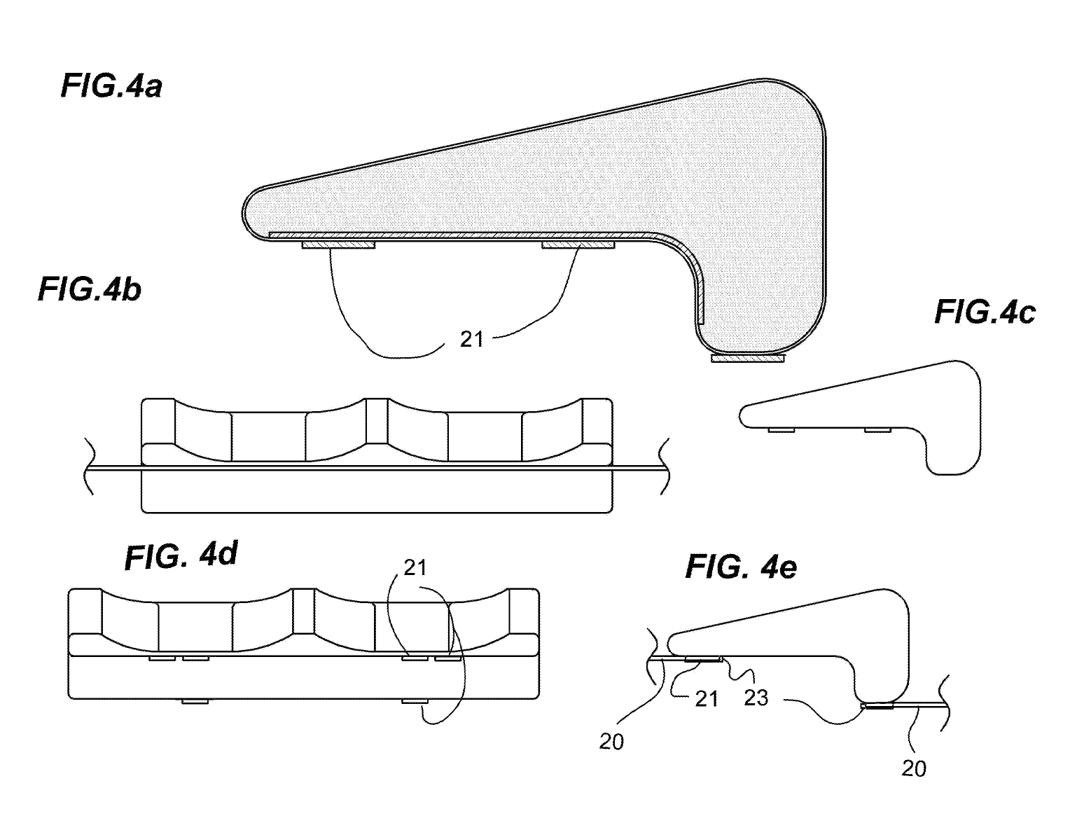

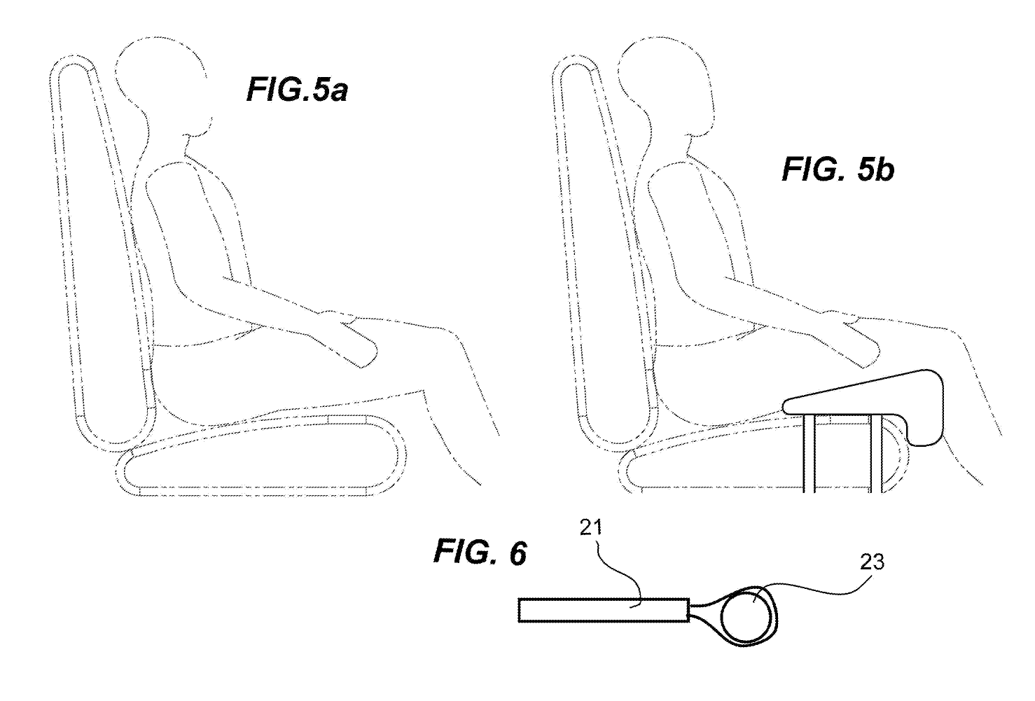

The car seat riser (10) can optionally be shaped so as to conform with the contour of the thighs. For example, as shown in FIG. 4b, it has a W-shape when seen from the front.

The straps (20) can be located side to side as per FIGS. 4a-c or front and back as per FIGS. 4d-e simply by sliding them out of their loops (21) the same way a belt can be pulled out from pants loops and putting them back in the appropriate set of loops (21) and blocked by blocking members (23). In other words the loop (21) pairings are perpendicular to each other. The straps (20) can hook to any appropriate parts of the seat (16) or hooks to the opposite end of the strap (20).

The seat riser (10) is formed as having a rigid shape formed by a molded rigid material, and further includes a compressible material surrounding and enclosing said molded rigid material, such that the car seat riser (10) retains its shape yet also offers an ergonomic shape for the comfort of a user by not constraining blood circulation and providing a good angle for the legs to bend.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, punch dies are the preferred tool used but other types of cutters such as rotary drill cutters could be used and still achieve a similar result.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A car seat riser for removably attaching to a seat portion of a car seat, said car seat riser comprising a body member having an L-shaped cross-section in a first axial direction and a W-shaped cross-section in a perpendicular axial direction to said first axial direction; said body member having a front edge that is thicker than a back edge thereby forming the body member in the shape of an L-shaped wedge in said first axial direction; and having an inner surface formed by said L-shaped cross-section that is adapted to conform to and fit upon a front edge portion of said seat portion of said car seat to thereby position said cars seat riser in proper position upon said seat portion, such that a user can sit in said car seat with said car seat riser wedged under said user's thighs thereby supporting and lifting said user's legs in a more comfortable and proper position.

2. The car seat riser of claim 1, further comprising at least one loop member connected to said inner surface; and at least one strap member adapted to be placed through said at least one loop member and adapted to be wrapped around said car seat to securely hold said car seat riser in place upon said seat portion of said car seat.

3. The car seat riser of claim 2, further comprising at least one loop member connected to a bottom portion of said front edge; and at least one strap member adapted to be placed through said at least one loop member and adapted to be wrapped around said car seat to securely hold said car seat riser in place upon said seat portion of said car seat.

4. The car seat riser of claim 2, wherein said at least one strap member includes a blocking member at one end adapted to prevent the end of said strap from being pulled through said at least one loop member; and wherein said at least one strap member includes a hook on an opposite end thereof from said blocking member adapted for removably securing to any portion of said car seat.

5. The car seat riser of claim 2, wherein there are at least two loop members connected to said inner surface, wherein two of said at least two loop members are attached such that the loop of at least one loop member is connected at a 90 degree angle with respect to a second of said at least two loop members, thereby resulting in a configuration wherein said at least one strap member can be used to secure said car seat riser to said seat portion of said car seat either from a direction following said first axial direction or said perpendicular axial direction.

6. The car seat riser of claim 3, wherein there are at least two loop members connected to said inner surface, wherein two of said at least two loop members are attached such that the loop of at least one loop member is connected at a 90 degree angle with respect to a second of said at least two loop members, thereby resulting in a configuration wherein said at least one strap member can be used to secure said car seat riser to said seat portion of said car seat either from a direction following said first axial direction or said perpendicular axial direction.

7. The car seat riser of claim 1, wherein said W-shaped cross-section is formed including left, right, and center straight ridges that are adapted to offer support to a user's thighs in the first axial direction.

8. The car seat riser of claim 2, wherein said at least one strap member is adjustable in length.

9. The car seat riser of claim 1, wherein said car seat riser is formed as having a rigid shape formed by a molded rigid material; and further includes a compressible material surrounding and enclosing said molded rigid material, such that said car seat riser retains its shape yet also offers comfort to a user.

10. A combination of a car seat and a car seat riser for removably attaching to a seat portion of said car seat, said car seat riser comprising a body member having an L-shaped cross-section in a first axial direction and a W-shaped cross-section in a perpendicular axial direction to said first axial direction; said body member having a front edge that is thicker than a back edge thereby forming the body member in the shape of an L-shaped wedge in said first axial direction; and having an inner surface formed by said L-shaped cross-section that is adapted to conform to and fit upon a front edge portion of said seat portion of said car seat to thereby position said cars seat riser in proper position upon said seat portion, such that a user can sit in said car seat with said car seat riser wedged under said user's thighs thereby supporting and lifting said user's legs in a more comfortable and proper position.

11. The car seat riser of claim 10, further comprising at least one loop member connected to said inner surface; and at least one strap member adapted to be placed through said at least one loop member and adapted to be wrapped around said car seat to securely hold said car seat riser in place upon said seat portion of said car seat.

12. The car seat riser of claim 11, further comprising at least one loop member connected to a bottom portion of said front edge; and at least one strap member adapted to be placed through said at least one loop member and adapted to be wrapped around said car seat to securely hold said car seat riser in place upon said seat portion of said car seat.

13. The car seat riser of claim 11, wherein said at least one strap member includes a blocking member at one end adapted to prevent the end of said strap from being pulled through said at least one loop member; and wherein said at least one strap member includes a hook on an opposite end thereof from said blocking member adapted for removably securing to any portion of said car seat.

14. The car seat riser of claim 11, wherein there are at least two loop members connected to said inner surface, wherein two of said at least two loop members are attached such that the loop of at least one loop member is connected at a 90 degree angle with respect to a second of said at least two loop members, thereby resulting in a configuration wherein said at least one strap member can be used to secure said car seat riser to said seat portion of said car seat either from a direction following said first axial direction or said perpendicular axial direction.

15. The car seat riser of claim 12, wherein there are at least two loop members connected to said inner surface, wherein two of said at least two loop members are attached such that the loop of at least one loop member is connected at a 90 degree angle with respect to a second of said at least two loop members, thereby resulting in a configuration wherein said at least one strap member can be used to secure said car seat riser to said seat portion of said car seat either from a direction following said first axial direction or said perpendicular axial direction.

16. The car seat riser of claim 10, wherein said W-shaped cross-section is formed including left, right, and center straight ridges that are adapted to offer support to a user's thighs in the first axial direction.

17. The car seat riser of claim 11, wherein said at least one strap member is adjustable in length.

18. The car seat riser of claim 10, wherein said car seat riser is formed as having a rigid shape formed by a molded rigid material; and further includes a compressible material surrounding and enclosing said molded rigid material, such that said car seat riser retains its shape yet also offers comfort to a user.
